(19) United States
(12) Patent Application Publication
(10) Pub. No.: US 2013/0028074 A1
(43) Pub. Date: Jan. 31, 2013

(54) METHOD AND APPARATUS FOR PROTECTING A COMMUNICATION NETWORK AGAINST FAILURE

(71) Applicants: Ron BANNER, Hadera (IL); Ariel ORDA, Haifa (IL)

(72) Inventors: Ron BANNER, Hadera (IL); Ariel ORDA, Haifa (IL)

(73) Assignee: TECHNION- RESEARCH AND DEVELOPMENT FOUNDATION LTD., Haifa (IL)

(21) Appl. No.: 13/562,428

(22) Filed: Jul. 31, 2012

Related U.S. Application Data
(63) Continuation of application No. 11/829,970, filed on Jul. 30, 2007, now abandoned.
(60) Provisional application No. 60/820,806, filed on Jul. 31, 2006.

(51) Int. Cl. H04L 12/24

(52) U.S. Cl. 370/218

(57) ABSTRACT

A method for protecting a communication network against failure, comprising the steps of: a) obtaining a primary network, represented by a graph of nodes and links, wherein each link has an associated capacity; b) computing a backup network, that includes nodes of the primary network and links that are not in the primary network; c) when a link of the primary network fails, rerouting communication traffic, through one or more links of the backup network, in order to bypass the failed link. Methods are suggested to determine the backup network, one method relates to expressing the objective and constraints on the backup network as linear or integer expressions, and a linear or integer programming tool is used to solve the equation system and provide optimal backup network.

### RELATED APPLICATIONS

The present invention relates to Provisional Patent Application Ser. No. 60/820,806 filed on Jul. 31, 2006.

### TECHNICAL FIELD

The present invention relates to communication in general, and to network protection and restoration in cases of a communication failure in particular.

### BACKGROUND

A communication network may include many communication and computing devices, such as computers, routers, switches, and others, also referred to as network elements. Two network elements in a network may be connected through one or more communication links. A communication link has various attributes, for instance, a capacity of the link. At any given moment, a fault or failure of a communication link connecting two network elements may occur. In some cases the amounts of communication traffic or data passing through a communication link at a particular period is high, and a failure of a communication link might cause a loss of vast amounts of data. When a communication link fails, recovery or restoration methods that direct traffic through alternative communication links are optionally used.

In order to allow for restoration or recovery from a link failure, protection resources are often allocated. In the art there are two basic approaches to allocate protection resources. In the first approach, resources are allocated upon demand, i.e., upon the arrival of a connection request, thus incurring a significant overhead in terms of connection set-up time. In the second approach protection resources are pre-allocated during the configuration phase of the network. Thus, protection resources are allocated for any potential pattern of connection requests, resulting in substantial over-provisioning of protection resources.

There is thus a need for a network protection method and tool which overcomes the above limitations, i.e. do not cause significant delays in communication time on one hand, and do not require excessive equipment resources on the other hand.

### SUMMARY

The disclosed subject matter relates to allocating dedicated resources in a network comprising nodes and links, to be used exclusively for handling failures of a network and also for fast restoration from a network failure. The dedicated resources comprise the same nodes as the primary network and additional links connecting such nodes.

In a preferred embodiment of the disclosed subject matter, there is thus provided a method for protecting the traffic in a primary network comprising at least two nodes and one or more primary links, each primary link having a capacity, such that each node is incident to at least one primary link, and each primary link connects two nodes, the method comprising the steps of: obtaining the primary network; determining a backup network, the backup network comprising the nodes of the primary network and one or more additional links; and when the a primary link fails, rerouting traffic through one or more additional links of the backup network. Within the method, determining the backup network optionally 1 comprises the steps of defining an initial backup network, the initial backup network comprising all nodes of the primary network and an initial backup link set comprising one or more backup links; expressing an objective function, the variables of the objective function being capacities associated with the backup links, the objective function being to minimize a sum of the capacities of all backup links; expressing one or more constraints for the backup network; and solving the objective function in accordance with the constraints, to obtain one or more values optimizing the objective function while adhering with the constraints. The method can further comprise the step of assigning the values to the capacity of the backup links. The method optionally comprises the step of removing from the initial backup link set one or more backup links assigned a capacity of zero. Within the method, one or more constraints optionally relate to a backup path for replacing a failed link comprising at most a predetermined number of backup links. Alternatively, one or more constraints optionally relate to the backup network comprising only links within the primary network. One or more constraints can relate to the backup network being unsplittable. Within the method, the objective is optionally expressed as a linear objective function, or the constraints are expressed as linear constraints. In a preferred embodiment, the initial backup link set comprises only primary links, or the initial backup link set comprises all possible links connecting two nodes within the primary network. Within the method, the constraints can be expressed as integer constraints. Within the method, each constraint optionally expresses one or more limitations selected from the group consisting of: nodal flow conservation of flow within the backup network; ensuring that a total capacity emitted or absorbed by a node incident to a link through the backup network, is at least equal to the capacity of the link; ensuring that upon a failure of a primary link, the total flow rerouted over each backup link is at most equal to the capacity of the primary link; ruling out a backup path having a number of segments exceeding a predetermined value; all capacities should be non-negative; a capacity of a backup link connecting two nodes should be either zero or equal to a capacity of a primary link connecting the two nodes; and forcing a directional capacities of each link in two directions to be equal. Within the method, determining the backup network optionally comprises the steps of: creating a backup link set, the backup link set being initially empty; ordering the primary links in a non-descending capacity order; for each primary link, determining whether adding the primary link to the backup link set creates a cycle within the backup link set; and if no cycle is created, adding a backup link having a capacity identical to the capacity of the primary link to the backup link set. Within the method, the backup network computed for an N-node primary network that is a Waxman network, optionally implies a capacity increase for the primary network of a factor of O(1/N), and the backup network computed for an N-node primary network that is a Power-Law network optionally implies a capacity increase for the primary network of a factor of O(1/lnN). Within the method, the primary network can be selected from of the group consisting of a network carrying computerized information, an electricity network, a telephony information network, a water supply network, a sewage network, a physical supply network, and a train network.

Another preferred embodiment of the disclosed subject matter relates to a method for determining a backup network for a primary network, the primary network comprising at least two nodes and at least one primary link, each primary link having a capacity, such that each node is incident to an at least one primary link, and each primary link connects two nodes, the backup network comprising at least two nodes and at least one backup link having a capacity, the method comprising the steps of: defining an initial backup network, the initial backup network comprising all nodes of the primary network and an initial backup link set comprising one or more backup links; expressing an objective function, the variables of the objective function being capacities associated with the backup links, the objective function being to minimize a sum of the capacities of all backup links; expressing one or more constraints for the backup network; and solving the objective function in accordance with the constraints, to obtain one or more values optimizing the objective function while adhering with the constraints.

Yet another preferred embodiment of the disclosed subject matter relates to a method for determining a backup network for a primary network, the primary network comprising two or more nodes and one or more primary links, each primary link having a capacity, such that each node is incident to one or more primary links, and each primary link connects two nodes, the backup network comprising two or more nodes and one or more backup links having a capacity, the method comprising the steps of: creating a backup link set, the backup link set being initially empty; ordering the primary links in a non-descending capacity order; for each primary link, determining whether adding the primary link to the backup link set creates a cycle within the backup link set; and if no cycle is created, adding a backup link having a capacity identical to the capacity of the primary link to the backup link set.

Yet another preferred embodiment of the disclosed subject matter relates to an apparatus for protecting the traffic in a primary network comprising at least two nodes and at least one primary link, each primary link having a capacity, such that each node is incident to one or more primary links, and each primary link connects two nodes, the apparatus comprising a computing platform for executing: a component for obtaining the primary network; a component for determining a backup network, the backup network comprising the nodes of the primary network and one or more additional links; and a component for rerouting traffic through one or more additional links of the backup network. Within the apparatus, the component for determining the backup network optionally comprises a component for defining an initial backup network, the initial backup network comprising all nodes of the primary network and an initial backup link set comprising one or more backup links; a component for expressing an objective function, the variables of the objective function being capacities associated with the at backup links, the objective function being to minimize a sum of the capacities of all backup links; a component for expressing one or more constraints for the backup network; and a component for solving the objective function in accordance with the constraints, to obtain one or more values optimizing the objective function while adhering with the constraints. Within the apparatus, the component for determining the backup network optionally comprises a component for creating a backup link set, the backup link set being initially empty; a component for ordering the primary links in a non-descending capacity order; a component for determining whether adding the primary link to the backup link set creates a cycle within the backup link set; and a component for adding a backup link having a capacity identical to the capacity of the primary link to the backup link set.

Yet another preferred embodiment of the disclosed subject matter relates to a computer readable storage medium containing a set of instructions for a general purpose computer, the set of instructions comprising: defining an initial backup network, the initial backup network comprising all nodes of a primary network and an initial backup link set comprising one or more backup links; expressing an objective function, one or more variables of the objective function being capacities associated with the backup links, the objective function being to minimize a sum of the capacity of the backup links; expressing one or more constraints for the backup network; and solving the objective function in accordance with the constraints, to obtain one or more values optimizing the objective function while adhering with the constraints.

Yet another preferred embodiment of the disclosed subject matter relates to a computer readable storage medium containing a set of instructions for a general purpose computer, the set of instructions comprising: creating a backup link set, the backup link set being initially empty; ordering the primary links in a non-descending capacity order; for each primary link, determining whether adding the primary link to the backup link set creates a cycle within the backup link set; and if no cycle is created, adding a backup link having a capacity identical to the capacity of the primary link to the backup link set.

### BRIEF DESCRIPTION OF THE DRAWINGS

Non-limiting embodiments of the invention will be described with reference to the following description of exemplary embodiments, in conjunction with the figures. The figures are generally not shown to scale and any sizes are only meant to be exemplary and not necessarily limiting. In the figures, identical structures, elements or parts that appear in more than one figure are preferably labeled with a same or similar number in all the figures in which they appear, in which:

FIG. 1A shows a graph representation of a network example, in accordance with an exemplary embodiment of the invention;

FIG. 1B shows a flowchart of a method for providing backup to a primary network using a backup network;

FIG. 2 is a table describing increase in capacity due to design constraints, in accordance with exemplary embodiments of the invention;

FIG. 3 is a flow chart of the main steps in a method for designing a backup network, in accordance with an exemplary embodiment of the disclosed subject matter; and

FIG. 4 is a flow chart of the main steps in another preferred method for designing a backup network, in accordance with another exemplary embodiment of the disclosed subject matter.

### DETAILED DESCRIPTION

The disclosed subject matter generally relates to protecting the traffic in a network against failures.

In exemplary embodiments of the disclosed subject matter, given a primary network used in normal operation mode to transfer information, a backup network is determined for the primary network wherein the backup network can reroute all affected traffic in the network if one or more links within the primary network fail. The backup network is defined as additional links to the links of the primary network, rather than as allocating parts of the capacity of the primary network for backup purposes. Upon a failure of any link of the primary network, the traffic on that link is rerouted through bypass paths which all belong to the backup network. The dedicated resources are thus allocated to links of the backup network, so these links can function when one or more failures are experienced by the primary network. The backup network comprises dedicated resources to be used exclusively for handling network failures in the primary network. The resources are allocated in advance when the network is configured. It is desired to construct a backup network which can cover up for a failure in any link of the primary network, with as little extra cost as possible.

In exemplary embodiments of the invention, determining a backup network for a given primary network is formulated as a network design problem with an objective of minimizing the total spare capacity of the backup network.

A network can be abstracted or modeled as a directed graph G=(V, E), wherein V is the set of nodes, or network element, and E is the set of edges or links between two network elements. In the case of computerized network, each node is preferably a computing platform such as a router, a server, a desktop computer, a laptop computer, or the like, and each edge is a communication channel between two nodes. The communication channel can be wired or wireless and can employ any known hardware or protocol. Each edge or link (i, j) connecting network elements i and j in the graph, is associated with at least one attribute, that is a capacity c(i, j) of the link (i,j).

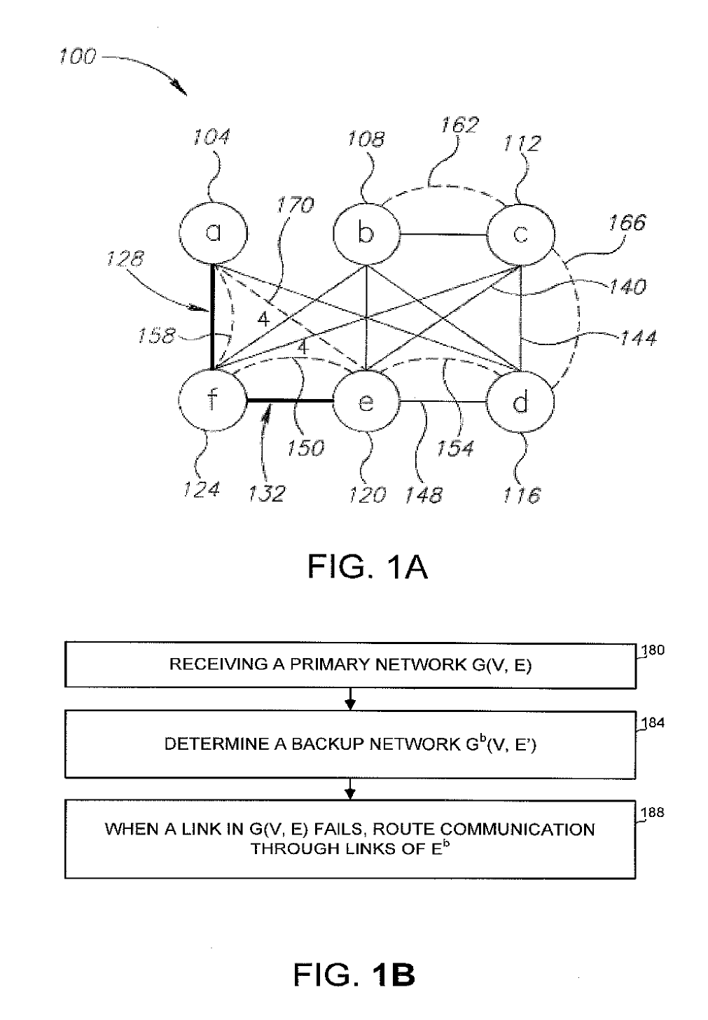

FIG. 1A shows a graph representation 100 of a non-limiting network example, according to an exemplary embodiment of the disclosed subject matter. The graph comprises nodes a (104), b 108, c 112, d 116, e 120 and f 124. Solid lines connecting two network elements, such as edges (a, t) 128, (c, e) 140 and (c, d) 144 represent direct connectivity in a given primary network between the two connected nodes. The exemplary network of FIG. 1 is undirected and the capacity of all links in each direction is 1 Mb/sec except for the bold links (a,f) 128 and (f,e) 132 that have a capacity of 5 Mb/sec. The dashed lines represent a backup network, all links having a default capacity of 1 Mb/sec unless otherwise indicated. The shown backup network provides protection against the failure of any link in the primary network. For example, upon a failure of the unit capacity link (b,e), it is possible to reroute, exclusively over the backup network, traffic in a rate of 1 Mb/sec through the bypass path (b,c,d,e). Similarly, when link (a,f) that has a capacity of 5 Mb/sec fails, it is possible to reroute 1 Mb/sec of traffic through the bypass path (a,e,f) and 4 Mb/sec through the bypass path belonging to the backup network (a,f). Bypass paths that protect different links in this primary network can intersect each other or share the same amount of bandwidth to achieve efficiency. For example, the links (b,e) and (c,e) are protected by the bypasses (b,c,d,e) and (c,d,e), respectively, with the shared links (c,d) and (d,e). The number of graph edges in a path is referred to as a hop-count, for instance, the path (c,d,e) has a hop-count of 2 because the path includes 2 edges (c,d) and (d,e).

Referring now to FIG. 1B, showing a flowchart of the main steps in a preferred embodiment of the disclosed method. On step 180, a network G(V, E) is received, wherein V is the set of nodes and E is a set of edges connecting the nodes. On step 184, a backup network G^{b} (V, E^{b}) is determined, using the same node set V, and a set of additional links E^{b}. G^{b} is determined such as to ensure that in case of failure of any link e belonging to E, the relevant traffic can be rerouted through links belonging to E^{b}. On step 188, when a link belonging to E indeed fails, all traffic is rerouted through links belonging to E^{b}.

Given a primary network G(V,E) with capacity cₑ for each link eεE. Let N=|V| and M=|E|. It is assumed that the network is represented by an undirected graph. However, the transition between a directed graph and an undirected graph is known in the art. Undirected graphs are preferably used to model various networks, for instance optical networks, in which adjacent nodes are usually connected by a pair of (identical) fibers carrying information in opposite directions.

An objective of some embodiments of the disclosed subject matter is to construct a backup network G^{b}(V,E^{b}) that can backup the traffic carried by all links in G(V,E). Therefore it is required to find a set of links wherein each link connect two nodes of V, i.e. E^{b}⊂V×V and backup capacities {c_{b}_{^{b}}} for these links, so that G^{b}(V,E^{b}) can be used to reroute the traffic of any one or more primary links e εE once the links fail.

In an exemplary embodiment, design constraints, also referred to as design requirements, are considered in designing a backup network. Some exemplary design constraints relevant for efficient deployment of backup networks are described below.

In a first exemplary design constraint, each link in the primary network should be protected by a bypass path fully contained in the backup network, with a bounded hop-count. A bounded hop-count means that a limited number of nodes is to be visited along the path replacing the failed link. Limiting the hop-count on each bypass path is effective in meeting Quality of Service (QoS) requirements. Queuing delay in congested networks increases significantly with the number of hops, which should thus be limited. In addition, for example in optical networks, the signal quality is deteriorated as it travels over multiple hops.

Another exemplary design constraint relates to the topology of the resulting backup network. Such requirement restricts the backup network to be a sub-graph of the primary network, i.e. there will be no link between two nodes in the backup network, unless there was such link in the primary network. With this constraint, the physical construction of the backup network is easier, since the backup network is limited to the links of the primary network. When the backup network is indeed a sub-graph of the primary network, the duct systems that contain the physical equipment such as the communication cables of the primary network can be used to thread all equipment of the backup network, thus avoiding extra digging. Complying with this constraint enables a user to avoid hardware installation in access of the primary network. When the backup network is a sub-graph of the primary network, it is possible to make the initial bandwidth the sum of the normal capacity and the backup capacity, and allocate for backup purposes the relevant fraction of the bandwidth of each primary link for protection purposes. A backup link is generally used for protecting and passing traffic when a failure occurs in a link other than the primary link connecting the same endpoints as the backup link. Thus, the backup network is defined over the (available) primary network infrastructure and no hardware installation is required

Another exemplary design constraint relates to bounding the number of bypass paths that protect each primary link. Such constraint may arise from a number of reasons: first, splitting traffic between multiple bypass paths can cause packets to arrive out of order, thus increasing delivery latency and buffering requirements; second, the complexity of a scheme that distributes traffic among multiple bypasses considerably increases with the number of paths; third, often there is a physical limit on the number of explicit bypass paths, such as label-switched paths in Multiprotocol Label Switching (MPLS) that can be set up between a pair of nodes.

The following types of backup networks are can be considered in relation to the disclosed subject matter: 1. Unsplittable backup networks have a bypass path p between the end-nodes of each primary link eεE, such that p can carry all the traffic of e once e fails i.e., the capacity of p (denoted by c(p)) is at least cₑ, the capacity of e. 2. Splittable backup networks have a collection of bypass paths P(e) between the end-nodes of each primary link e E such that the total capacity of all protection paths in P(e) is at least the capacity of e i.e., Σ_{pεP(e)}c(p)≧cₑ.

In exemplary embodiments of the disclosure, among all possible backup networks that satisfy one or more of the above mentioned constraints or restrictions, it is required to determine and construct the backup network having the lowest possible total capacity i.e., Σ_{eεE}_{^{b}}c_{c} is minimized. This is required in order to avoid unnecessary resource allocation.

In some embodiments of the invention the focus is on the single link failure model i.e., at any given time there exists at most one failed link. This assumption enables to construct backup networks that are significantly more efficient in terms of capacity, since bypass paths in the backup network for two different primary links can intersect each other and share the same amount of capacity.

Each of the design constraints or requirements mentioned above levies a toll in terms of the required backup capacity. Accordingly, extra capacity must be allocated to the backup network due to the imposition of each combination of the above design requirements or constraints. Specifically, the capacity increase is quantified as follows: given a set of one or more design constraints, the worst-case ratio between the minimum capacity that needs to be allocated to a backup network that satisfies the constraint set and the minimum capacity that needs to be allocated to a backup network that has no constraints to satisfy is determined.

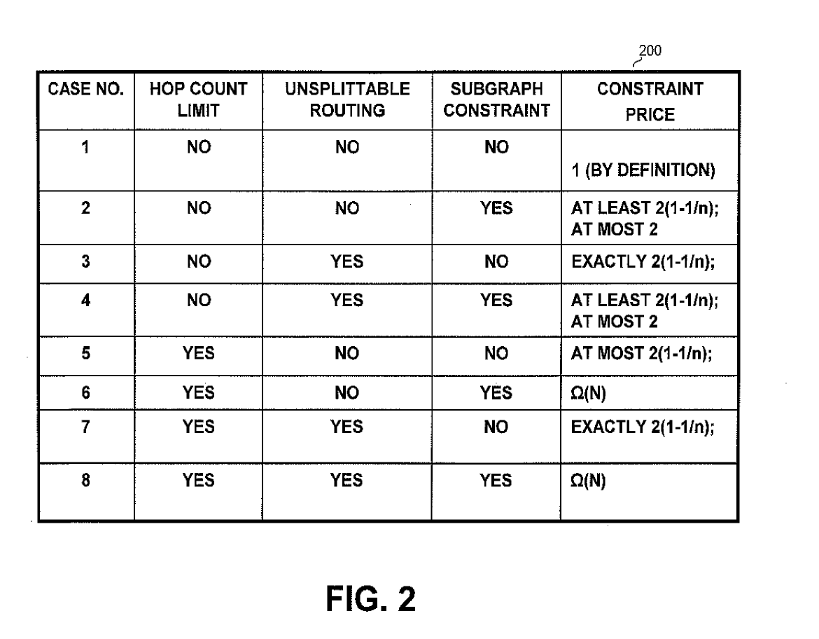

Referring now to FIG. 2, in which table 200 shows the upper and lower bounds of the worst-case increase in the total capacity allocated for a backup network due to each combination of the following design constraints: (i) a hop-count limit of two on each bypass path; (ii) supporting unsplittable routing at the backup network (Le., upon any failure of a primary link, there is at least one bypass path that can reroute all affected traffic); (iii) restricting the topology of the backup network to be a sub-graph of the topology of the primary network.

Any combination of the abovementioned constraints can be represented as a triplet of binary indicators (H,U,S) in which possible values are indicated as follows: Indicator H takes the value H+ if the 2-hop count limit is imposed, and the value H− otherwise, indicator U takes the value U+ if it is required to support unsplittable routing, and the value U− otherwise, and indicator S takes the value S+ if the subgraph constraint is imposed, and the value S− otherwise.

In exemplary embodiments of the invention, Table 200 provides design rules for efficient construction of backup networks. First, all combinations of design constraints except cases 1, 6, and 8 of table 200 increase the extra capacity by a factor of at most 2; thus, their enforcement provides performance benefits, while still incurring only a small cost in terms of extra capacity. Thus, although backup networks induce minor overhead for unconstrained cases, the overhead remains small also when the corresponding combinations of design constraints are imposed.

As seen in cases 6 and 8 in table 200, when the hop-count limit constraint and the sub-graph constraint are concurrently imposed, the extra capacity increases significantly by a factor relative to the number of nodes, i.e. Ω(N). Since such increase is usually impractical, only one out of the two design constraints is preferably considered. Table 300 also shows that the cost incurred by imposing the requirement for unsplittable routing at the backup network does not increase if a requirement for small hop-count is imposed as well. Thus, when the requirement to support unsplittable routing is imposed, hop-count limit constraint can be also imposed at no additional resource allocation.

For the above mentioned design constraints, several polynomial running time methods for constructing backup networks can be designed. Such methods aim at minimizing the capacity allocated for the backup networks while satisfying a given set of constraints. Specifically, two types of methods or algorithms are described hereinafter. The first imposes the requirement to support unsplittable routing at the backup network while the other allows traffic to be split among several bypasses (i.e., the unsplittable routing requirement is not imposed). For the splittable case, a polynomial running time algorithm that optimally solves the problem while considering either one or both of the other design constraints (namely, the hop-count limits and the sub-graph constraint) is presented. For the unsplittable case, two algorithms that approximate the optimal solution by a factor of at most 2, are presented. The first approximation is designed to meet the sub-graph constraint while running in a time complexity of O(N·M) for M-link N-node networks, and the other is designed to meet the hop-count limit while running in a (linear) time complexity of O(N).

For some specific network types, establishing backup networks for primary networks induces small overhead in terms of extra capacity. For example, in Waxman networks, described in B. M. Waxman, Routing of Multipoint Connections, IEEE Journal on Selected Areas in Communications, 6:1617-1622,1988, it is sufficient to increase the total capacity allocated to the primary network by a factor of O(1/N) for an N-node primary network in order to construct a backup network. In Power-Law networks, described in M. Faloutsos, P. Faloutsos, and C. Faloutsos, On Power-law Relationships of the Internet Topology, in Proc. ACM SIGCOMM, Cambridge, Mass., September 1999 it is sufficient to increase the total capacity allocated to the primary network by a factor of O(1/lnN). Thus, for both models it is possible to construct backup networks that fully protect against any single link failure at a minor price of extra capacity.

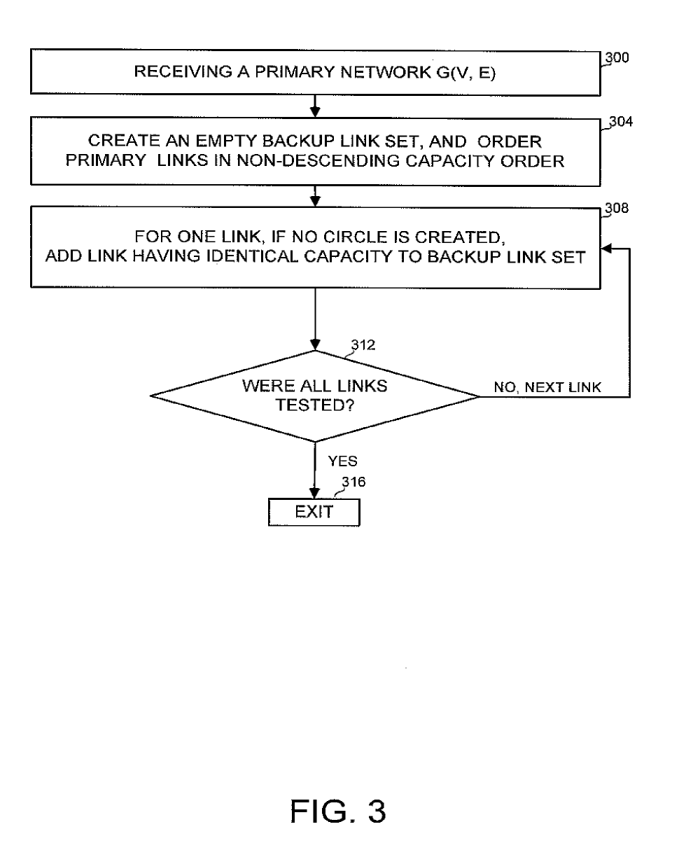

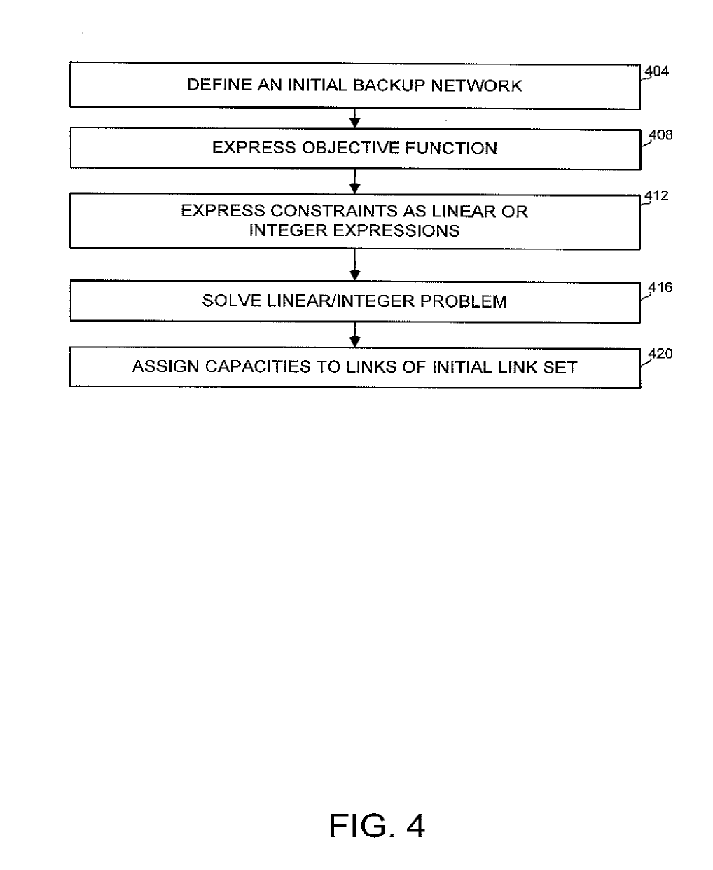

In accordance with another preferred embodiment of the present invention there are thus provided methods for optimal construction of a backup network for a primary network, the backup network satisfying certain design constraints. FIG. 3 and FIG. 4 provide methods for determining a backup graph. FIG. 3 shows a fast method which provides a backup network having at most twice the capacity of the minimal capacity as shown in FIG. 2. FIG. 4, however, provides the optimal result, i.e. a backup network whose capacity does not exceed the value shown in table 200, but requires more computing resources. Referring now to FIG. 3, showing a flowchart of the main steps in a method for constructing a backup network for a primary network G(V,E). The method selects edges from the primary network, and returns a collection of backup links having a capacity which is at most twice the minimal capacity for the network as stated in table 200 of FIG. 2. The method is preferably implemented as a computer application comprising computer instructions for carrying out the following steps. The computer application can be developed using any programming language such as C#, C++, C#, Java, VB or others, and under any development environment, such as J2EE, .Net or others. The application can be executed by any general-purpose processor. Alternatively, the method can be implemented as firmware ported for a specific processor such as digital signal processor (DSP) or microcontrollers, or can be as hardware or configurable hardware such as field programmable gate array (FPGA) or application specific integrated circuit (ASIC).

On step 300, a primary network G(V,E) is received. For each v εV, the maximum capacity of a link that is incident to v is denoted by C(v), i.e.,

$$C ( v ) = {min}_{( v , u ) ∈ E} \{ c ( v , u ) \}$$

where c(v,u) is the capacity of the link (v,u) for any U. Thus, a lower bound on the minimum capacity of any unrestricted backup network is

$$\frac{1}{2} \cdot {\sum }_{v ∈ V} C ( v ) .$$

On step 304, an empty backup link set is created, and the primary links are ordered in a non-descending capacity order.

On step 308, the next link in the order determined on step 304 is determined. It is then determined if adding this link to the backup link set creates a cycle within the backup network. If not, a link having the same capacity as the checked link is added to the backup link set. On step 312, it is determined whether all links in the primary network were tested. If yes, the method finishes and returns the backup link set, otherwise the method re-visits step 208 for the next primary link. This method provides a backup network with a topology that is a subgraph of the primary network, i.e. only edges that exist in the primary network can be added to the backup network. If such constraint is applied, the total capacity allocated for the backup network increases at most by a factor that is between

$$2 \cdot ( 1 - \frac{1}{N} )$$

and 2 for both splittable and unsplittable backup networks, wherein N=|V|, i.e. the number of nodes in the graph.

It will be appreciated by a person skilled in the art, that in an undirected graph, each undirected link in the primary network G(V,E) can be transformed into two directed links having opposite directions and each having the same capacity as the original undirected link. Thus, an undirected link having a capacity cₑ can be represented by two directed links such that each of the links can transfer at most cₑ flow units per time unit. Therefore, the total capacity of all links in the undirected representation equals half of the total capacity of all links in the directed representation. In particular, minimizing the total capacity of all links in the directed representation also minimizes the total capacity in the undirected representation.

Referring now to FIG. 4, showing the main steps in a flowchart of a preferred embodiment of a method for constructing a backup network under constraints, using linear programming or integer programming methods. The method is preferably implemented as a computer application comprising computer instructions for carrying out the following steps. The computer application can be developed using any programming language such as C#, C++, C#, Java, VB or others, and under any development environment, such as J2EE, .Net or others. The application can be executed by any general-purpose processor. Alternatively, the method can be implemented as firmware ported for a specific processor such as digital signal processor (DSP) or microcontrollers, or can be as hardware or configurable hardware such as field programmable gate array (FPGA) or application specific integrated circuit (ASIC).

Denote by fₑ_{^{b}}(e) the total flow rerouted over the backup link e^{b}εE^{b} upon a failure of link e, and let fₑ_{^{b}}^{h}(e) be the total flow over e^{b}(w₁,w₂)εE^{b} that is rerouted from u to w₁ through bypasses with a hop-count of exactly h, upon a failure on the primary link e.

On step 404, an initial backup network is defined, comprising all nodes of the initial network and an initial link set. If the backup network must be a subgraph of the primary network then the links of the initial backup network are defined to be identical to the links of the primary network. Otherwise, the initial link set is defined to be the full set of edges, i.e. V×V. In steps detailed further below, a part of the links in the initial to backup network will be assigned a capacity of 0, and will thus be excluded from the backup network.

On step 408 an objective function is formulated using the variables {{fₑ_{^{b}}^{h}(e)}, {cₑ_{^{b}}}}, for any eεE^{b}. The objective is to find a splittable backup network that satisfies the hop-count and subgraph constraints, while minimizing the total capacity of the backup network, i.e.

$$Minimize {\sum }_{{e}^{b} ∈ {E}^{b}}^{ } {c}_{{e}^{b}} \qquad ( 1 )$$

Objective function (1) defines the variables to be minimized, being the capacities of the links of the backup network. Objective function (1) thus minimizes the total capacity allocated to the backup network G^{b}(V,E^{b}).

On step 412 a set of limitations expressing the constraints is formulated using the same variables as the objective. The exemplary constraints relate to the hop-count and subgraph constraints. The constraints are preferably expressed the following limitations:

$${\sum }_{{e}^{b} ∈ O ( v )}^{ } {f}_{{e}^{b}}^{h} ( e ) - {\sum }_{{e}^{b} ∈ I ( v )}^{ } {f}_{{e}^{b}}^{h - 1} ( e ) = 0 \qquad ( 2 )$$

for any eεE, any h between 0 and a predetermined upper hop limit H, and any vεV excluding the link connecting sₑ and tₑ. Equation (2) relates to the nodal flow conservation limitation of the backup flow. Equation (2) implies that upon a failure of any primary link e connecting sₑ and tₑ to total backup flow that enters any node excluding sₑ and tₑ and has traversed paths from sₑ to v of hop-count h-1 must equal the total backup of flow emanating out of that node through paths having a hop count h.

$$\begin{matrix}{\sum }_{{e}^{b} ∈ O ( {s}_{e} )}^{ } {f}_{{e}^{b}}^{0} ( e ) \geq {c}_{e} & ( 3 ) \\ {\sum }_{{e}^{b} ∈ T ( {t}_{e} )}^{ } {\sum }_{h = 0}^{H} {f}_{{e}^{b}}^{h} ( e ) \geq {c}_{e} & ( 4 )\end{matrix}$$

for any eεE. Equations (3) and (4) imply that for each primary link e, the backup network enables at least a total capacity of cₑ along the paths that connect each of the end-nodes of e, i.e. ensuring that a total capacity emitted or absorbed by a node incident to a link through the backup network, is at least equal to the capacity of the link; specifically, limitation (3) relates to emitting from the end-node sₑ of each primary link e=sₑ→tₑ a backup flow of at least cₑ flow units; similarly, limitation (4) relates to absorbing at the end node tₑ of each primary link e=sₑ→tₑ, a total backup flow of at least cₑ flow units.

$${\sum }_{h = 0}^{H} {f}_{{e}^{b}}^{h} ( e ) \leq {c}_{{e}^{b}} \qquad ( 5 )$$

for any eεE, and any e^{b}εE^{b}. Equation (5) ensures that, upon a failure of any primary link e, the total flow rerouted over each backup link e^{b} is at most cₑ_{^{b}}.

fₑ_{^{b}}^{h}(e)=0 (6)

for any eεE, any e^{b}εE^{b}, and any h or exceeding the predetermined limit H. Equation (6) rules out flows that violate the hop restriction.

fₑ_{^{b}}^{h}(e)≧0 (7)

cₑ_{^{b}}≧0 (8)

for any eεE, for any e^{b} εE^{b}, and for any h between 0 and the predetermined limit H. Limitations (7) and (8) restrict all variables to be non-negative capacities and flows.

fₑ₁_{^{b}}^{h}(e)=fₑ₂_{^{b}}^{h}(e) (9)

for any e ⊂E, any h between 0 and H, and any c₁^{b}, c₂^{b} εE^{b} such that e₁^{b} connect the same nodes. Equation (9) restricts the solution to be symmetrical; hence, it rules out all solutions that are not feasible for the original undirected network, since the capacity of each link is required to be equal in both directions.

On step 416, objective function (1) and limitations (2)-(9) are fed into any linear programming solving machine, tool, package, or application, such as CPLEX and/or MOSEK. CPLEX is by ILOG (www.ilog.com).

On step 420, the values provided by the linear program solver are assigned as the capacities of the links belonging to the initial backup networks. The links assigned a capacity of 0 are practically removed from the backup network, since no traffic is assumed to pass through them when the need rises to overcome a primary link failure.

Since Equation (7) allows flow variables {fₕ_{^{b}}^{e}(e)} to take any non-negative value, the rerouted flow upon a failure of any link e can be split among several paths; hence, the solution consisting of the variables {cₑ_{^{b}}} constitutes an optimal splittable backup network for the given hop—count restriction H. In order to transfer the backup flow via an unsplittable network, it is required to modify equation (7) so that each variable fₑ_{^{b}}^{h}(e) would take either the value 0 or the value cₑ for each primary link e, each backup link e^{b}, and h between 0 and H. Objective function (1) and Equations (2)-(9) are then solved by an integer programming tool, which thus provides an optimal unsplittable solution to the backup network.

Appendix A entitled “Designing Low-Capacity Backup Networks for Fast Restoration” is incorporated in its entirety into the detailed description of this specification.

A person skilled in the art will appreciate that further changes and enhancements can be made without deviating from the spirit of the disclosure. One or more constraints can be expressed in a different manner. Additional or different constraints can be imposed and phrased as linear or integer equations or expressions, and thus be solved by a relevant tool or application.

It will be further appreciated that the disclosed subject matter can be used for a wide variety of applications, including but not limited to networks carrying computerized information, electricity, telephony information, water supply, sewage, physical supply networks, train networks, and others.

The present disclosure has been described using non-limiting detailed descriptions of embodiments thereof that are provided by way of example and are not intended to limit the scope of the invention. It should be understood that features described with respect to one embodiment may be used with other embodiments and that not all embodiments of the invention have all of the features shown in a particular figure or described with respect to one of the embodiments. It is noted that some of the above described embodiments may describe the best mode contemplated by the inventors and therefore include structure, acts or details of structures and acts that may not be essential to the invention and which are described as examples.

While the above description has focused on methods, it is meant to also encompass apparatus for carrying out the invention. The apparatus may be a system comprising of hardware and software.

Thus, a system for protecting a network from failures may comprise one or more computing platforms or programmed computers or network appliances, executing a component for determining a backup network for the primary network, and a component for rerouting traffic through the backup network in the case a link of the primary network fails. The components may be executed by different computing platforms and on different times, wherein the backup network determination component is executed when the network is being planned, while the rerouting component is executed when the network is in normal usage. In one preferred embodiment the component for determining the backup network comprises a component for defining an initial backup network; a component for expressing an objective function associated with the capacities of links in the backup network backup link; a component for expressing constraints for the backup network; and a component for solving the objective function in accordance with the constraints, to capacities for the backup network. In another preferred embodiments, the component for determining the backup network comprises a component for ordering the links of the primary network in a non-descending capacity order; a component for determining whether a link from the primary network added to the backup link set creates a cycle within the backup link set, and a component for adding links having capacity equal to the capacity of the primary link to the backup link set.

The apparatus may include various computer readable media having suitable software thereon, for example, diskettes and computer and/or flash RAM.

Structure and acts described herein are replaceable by equivalents, which perform the same function, even if the structure or acts are different, as known in the art. Therefore, only the elements and limitations as used in the claims limit the scope of the invention. When used in the following claims, the terms “comprise”, “include”, “have” and their conjugates mean “including but not limited to”.

We claim:

1. A method for protecting the traffic in a primary network comprising at least two nodes and a multiplicity of primary links, each primary link having a capacity, such that each node is incident to at least one primary link, and each primary link connects two nodes, the method comprising the steps of:
obtaining the primary network;
configuring the primary network by determining and allocating a backup network, the backup network comprising all nodes of the primary network and an at least one dedicated backup link additional to the at least one primary link; and
when the primary network is used and one of the at least one primary link fails, rerouting traffic through at least one additional link of the backup network, wherein the backup network does not contain a cycle.

2. The method of claim 1 wherein determining the backup network comprises the steps of:
defining an initial backup network, the initial backup network comprising all nodes of the primary network and an initial backup link set comprising at least one backup link;
expressing an objective function, the variables of the objective function being capacities associated with the at least one backup link, the objective function being to minimize a sum of the capacities of all backup links;
expressing at least one constraint for the backup network; and
solving the objective function in accordance with the at least one constraint, to obtain at least one value optimizing the objective function while adhering with the constraints.

3. The method of claim 2 further comprising the step of assigning the at least one value to the capacity of the at least one backup link.

4. The method of claim 2 further comprising the step of removing from the initial backup link set an at least one backup link assigned a capacity of zero.

5. The method of claim 2 wherein the at least one constraint relates to a backup path for replacing a failed link comprising at most a predetermined number of backup links.

6. The method of claim 2 wherein the at least one constraint relates to the backup network comprising only links within the primary network.

7. The method of claim 2 wherein the at least one constraint relates to the backup network being unsplittable.

8. The method of claim 2 wherein the objective is expressed as a linear objective function.

9. The method of claim 2 wherein the at least one constraint is expressed as a linear constraint.

10. The method of claim 2 wherein the initial backup link set comprises only links from the multiplicity of primary links.

11. The method of claim 2 wherein the initial backup link set comprises all possible links connecting two nodes within the primary network.

12. The method of claim 2 wherein the at least one constraint is expressed as an integer constraint.

13. The method of claim 2 wherein the at least one constraint expresses one or more limitations selected from the group consisting of: nodal flow conservation of flow within the backup network; ensuring that a total capacity emitted or absorbed by a node incident to a link through the backup network, is at least equal to the capacity of the link; ensuring that upon a failure of the at least one primary link, the total flow rerouted over each backup link is at most equal to the capacity of the at least one primary link; ruling out a backup path having a number of segments exceeding a predetermined value; all capacities should be nonnegative; a capacity of a backup link connecting two nodes should be either zero or equal to a capacity of a primary link connecting the two nodes; and forcing directional capacities of each link in two directions to be equal.

14. The method of claim 1 wherein determining the backup network comprises the steps of:
creating a backup link set, the backup link set being initially empty;
ordering the multiplicity of primary links in a non-descending capacity order;
for each primary link of the multiplicity of primary links, determining whether adding the primary link to the backup link set contains a cycle within the backup link set; and
if the backup link set does not contain a cycle, adding a backup link having a capacity identical to the capacity of the primary link to the backup link set.

15. The method of claim 1 wherein the backup network computed for a primary network that is a Waxman network having N nodes, implies a capacity increase for the primary network of a factor of O(1/N).

16. The method of claim 1 wherein the backup network computed for a primary network that is a Power-Law network having N nodes implies a capacity increase for the primary network of a factor of O(1/lnN).

17. The method of claim 1 wherein the primary network is selected from of the group consisting of: a network carrying computerized information, an electricity network, a telephony information network, a water supply network, a sewage network, a physical supply network, and a train network.

18. A method for determining a backup network for a primary network, the primary network comprising at least two nodes and at least one primary link, each primary link having a capacity, such that each node is incident to an at least one primary link, and each primary link connects two nodes, the backup network comprising at least two nodes and at least one dedicated backup link having a capacity, the method comprising the steps of:
defining an initial backup network, the initial backup network comprising all nodes of the primary network and an initial backup link set comprising an at least one backup link;
expressing an objective function, the variables of the objective function being capacities associated with the at least one backup link, the objective function being to minimize a sum of the capacities of all backup links;
expressing an at least one constraint for the backup network; and solving the objective function in accordance with the at least one constraint, to obtain an at least one value optimizing the objective function while adhering with the constraints;
wherein the backup network does not contain a cycle, and wherein the at least one backup link is additional to the at least one primary link.

19. A method for determining a backup network for a primary network, the primary network comprising at least two nodes and a multiplicity of primary links, each primary link having a capacity, such that each node is incident to an at least one primary link, and each primary link connects two nodes, the backup network comprising the at least two nodes and at least one backup link having a capacity, the method comprising the steps of:
creating a backup link set. the backup link set being initially empty;
ordering the multiplicity of primary links in a non descending capacity order;
for each primary link of the multiplicity of primary links, determining whether adding the primary link to the backup link set contains a cycle within the backup link set; and
if the backup link set does not contain a cycle, adding a backup link having a capacity identical to the capacity of the primary link to the backup link set;
wherein the backup link is dedicated and is additional to the at least one primary link.

20. An apparatus for protecting the traffic in a primary network comprising at least two nodes and a multiplicity of primary links, each primary link having a capacity, such that each node is incident to an at least one primary link, and each primary link connects two nodes, the apparatus comprising a computing platform for executing:
a component for obtaining the primary network;
a component for configuring the primary network by determining and allocating a backup network, the backup network comprises all nodes of the primary network and an at least one dedicated backup link additional to the at least one primary link, and the backup network does not contain a cycle; and
a component for rerouting traffic through an at least one additional link of the backup network when the primary network is used and one of the at least one primary link fails.

21. The apparatus of claim 20 wherein the component for determining the backup network comprises:
a component for defining an initial backup network, the initial backup network comprising all nodes of the primary network and an initial backup link set comprising an at least one backup link;
a component for expressing an objective function, the variables of the objective function being capacities associated with the at least one backup link, the objective function being to minimize a sum of the capacities of all backup links;
a component for expressing an at least one constraint for the backup network; and
a component for solving the objective function in accordance with the at least one constraint, to obtain an at least one value optimizing the objective function while adhering with the constraints.

22. The apparatus of claim 20 wherein the component for determining the backup network comprises:
a component for creating a backup link set, the backup link set being initially empty;
a component for ordering the multiplicity of primary links in a non-descending capacity order;
a component for determining whether adding a primary link to the backup link set, makes the backup link set contain a cycle;
and
a component for adding the backup link having a capacity identical to the capacity of the primary link to the backup link set.

23. A computer readable storage medium containing a set of instructions for a general purpose computer, for determining a backup network for a primary network, the primary network comprising at least two nodes and at least one primary link, each primary link having a capacity, such that each node is incident to an at least one primary link, and each primary link connects two nodes, the backup network comprising at least two nodes and at least one dedicated backup link having a capacity, the set of instructions comprising;
defining an initial backup network, the initial backup network comprising all nodes of a primary network and an initial backup link set comprising an at least one backup link;
expressing an objective function, an at least one variable of the objective function being a capacity associated with the at least one backup link, the objective function being to minimize a sum of the capacity of the at least one backup link;
expressing an at least one constraint for the backup network; and
solving the objective function in accordance with an at least one constraint, to obtain an at least one value optimizing the objective function while adhering with the constraints;
wherein the backup network does not contain a cycle, and wherein the at least one backup link is additional to the at least one primary link.

24. A computer readable storage medium containing a set of instructions for a general purpose computer for determining a backup network for a primary network, the primary network comprising at least two nodes and a multiplicity of primary links, each primary link having a capacity, such that each node is incident to an at least one primary link, and each primary link connects two nodes, the backup network comprising at least two nodes and at least one backup link having a capacity, the set of instructions comprising:
creating a backup link set, the backup link set being initially empty;
ordering the multiplicity of primary links m a nondescending capacity order;
for each primary link of the multiplicity of primary links, determining whether adding the primary link to the backup link set makes the backup link set contain a cycle; and
if the backup link set does not contain a cycle, adding a backup link having a capacity identical to the capacity of the primary link to the backup link set,
wherein the backup link is dedicated and is additional to the at least one primary link.
